(19) United States
(12) Patent Application Publication
(10) Pub. No.: US 2026/0146577 A1
(43) Pub. Date: May 28, 2026

(54) AMMONIA-HYDROGEN CO-COMBUSTION SYSTEM FOR MITIGATING COMBUSTION INSTABILITY AND EXHAUST GAS EMISSION

(71) Applicant: KOREA ADVANCED INSTITUTE OF SCIENCE AND TECHNOLOGY, Daejeon (KR)

(72) Inventors: Kyu Tae Kim, Daejeon (KR); Ukhwa Jin, Daejeon (KR)

(21) Appl. No.: 19/389,451

(22) Filed: Nov. 14, 2025

(30) Foreign Application Priority Data
Nov. 26, 2024 (KR) 10-2024-0170429

(51) Int. Cl. F02M 43/04; F02M 21/02

(52) U.S. Cl. CPC F02M 43/04; F02M 21/0206; F02M 2700/07; F02M 2700/126

(57) ABSTRACT

The present disclosure relates to a combustion system using carbon-free fuels such as hydrogen or ammonia, and more particularly, to an ammonia-hydrogen co-combustion system that enhances the reactivity of ammonia and reduces nitrogen oxides in exhaust gas after combustion.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### TECHNICAL FIELD

The present disclosure relates to a combustion system using carbon-free fuels such as hydrogen or ammonia, and more particularly, to an ammonia-hydrogen co-combustion system that enhances the reactivity of ammonia and reduces nitrogen oxides in exhaust gas after combustion.

### BACKGROUND ART

To effectively reduce carbon emissions during power generation, expanding renewable energy and transitioning to clean energy are essential. Gas (gas turbine) power generation is attracting attention as a power source that may address the intermittency of renewable energy. Unlike other power sources, the gas turbines are capable of rapid startup, and thus, primarily handle peak loads. The share of power generation by the gas turbines has been increasing, now accounting for more than 30% of the total. Furthermore, the excess renewable energy may be used to produce green hydrogen or ammonia, which can then serve as fuel for the gas turbines. This not only enhances the utilization of surplus power but also makes a significant contribution to reducing carbon emissions. Therefore, the gas turbines may form a complementary relationship with renewable energy, helping to overcome the instability in power supply caused by the intermittent nature of renewable energy. Furthermore, when hydrogen/ammonia co-combustion or full-firing technologies are applied to the gas turbines, decarbonization in the power generation sector may be further accelerated.

Ammonia is well known as a substance with excellent energy storability, as it can be easily liquefied under relatively low temperature and pressure conditions. Moreover, since ammonia contains a large amount of hydrogen within its fuel molecules, it is attracting attention as an economical medium for storing and transporting hydrogen. Furthermore, as the carbon-free fuel, ammonia can also be used directly as a power source, increasing its utility as we move toward a hydrogen economy.

However, ammonia flame has the disadvantage of having very low reactivity and emitting nitrogen oxides tens to thousands of times more than natural gas. To utilize ammonia as an environmentally friendly, carbon-free fuel, it is essential to effectively overcome the technical challenges associated with ammonia. Against this background, although research on ammonia combustion has been actively conducted in recent years, neither industry nor academia has yet presented a clear solution to this challenging issue. Therefore, the development of a carbon-free combustion technology that can dramatically increase ammonia's low reactivity and maximize the reduction of harmful exhaust emissions is required.

The disclosure of this section is to provide background information. Applicant does not admit that any information contained in this section constitutes prior art.

### SUMMARY

An aspect of the present disclosure provides an ammonia-hydrogen co-combustion system, a carbon-free combustion technology that can dramatically increase ammonia's low reactivity and maximize the reduction of harmful exhaust emissions.

In one general aspect, a combustion system includes: a combustion unit where first and second fuel gases are supplied and combusted; and a fuel nozzle unit connected to a front end of the combustion unit and supplying the first fuel gas to the combustion unit through a plurality of first nozzles and supplying the second fuel gas to the combustion unit through a plurality of second nozzles, in which the fuel nozzle unit includes the first and second nozzles partitioned from each other to independently control flow rates of each of the first and second fuel gases.

The first fuel gas may be one of a mixture of ammonia and air or a mixture of hydrogen and air, and the second fuel gas may be the other of the mixture of ammonia and air or the mixture of hydrogen and air.

A rear end of the fuel nozzle unit may be provided with a dump unit having the first and second nozzles, the dump unit may be partitioned into an inner region formed at a radial center and an outer region formed around a radially outer circumference of the inner region, and the first nozzle may be disposed in the inner region, and the second nozzle is disposed in the outer region.

The first nozzle may be supplied with a first fuel gas which is the mixture of ammonia and air, and the second nozzle may be supplied with a second fuel gas which is the mixture of hydrogen and air.

The first fuel gas may be supplied to the first nozzle in a rich condition with an equivalence ratio of 1 or greater, and the second fuel gas may be supplied to the second nozzle in a lean condition with an equivalence ratio of less than 1.

The combustion system may further include: a sampling unit sampling exhaust gas emitted from the combustion unit; and an analysis unit analyzing components of the exhaust gas sampled through the sampling unit.

The combustion system may further include: a control unit controls the flow rate and equivalence ratio of the first and second fuel gases when the nitrogen oxides analyzed by the analysis unit are greater than or equal to a predetermined level.

The control unit may detect the components of the exhaust gas in real time or at specific intervals and provide feedback on a hydrogen mole fraction or the supply amount of additional fuel gas.

The fuel nozzle unit may include: a first housing receiving the first fuel gas and transferring the received first fuel gas to a plurality of first nozzles; a second housing receiving the second fuel gas and transferring the received second fuel gas to a plurality of second nozzles; a plurality of first transfer pipes connecting a plurality of first outlets formed in the first housing to the plurality of first nozzles, respectively; and a plurality of second transfer pipes connecting a plurality of second outlets formed in the second housing to the plurality of second nozzles, respectively.

The first housing may be cylindrical, and have a front end formed with a first inlet for receiving the first fuel gas and a rear end formed with a plurality of first outlets formed for emitting the first fuel gas; and the second housing may be ring-shaped, and connected to the first housing so that the first housing passes through the center thereof, and may have a side surface formed with a second inlet for receiving the second fuel gas and a rear end formed with a plurality of second outlets for discharging the second fuel gas.

A plurality of first transfer pipes may be spaced apart from each other at a radial center of the first fuel nozzle unit, and a plurality of second transfer pipes may be spaced apart from each other at a radial outer periphery so as to surround the first transfer pipes.

A hydrogen flame generated by the second fuel gas injected from the second nozzle may be configured to surround an ammonia flame generated by the first fuel gas injected from the first nozzle.

According to the ammonia-hydrogen co-combustion system of the present disclosure, configured as described above, it is possible to improve the flame stability in the ammonia/hydrogen co-combustion environment and minimize the nitrogen oxide emissions, thereby preventing the environmental pollution.

Furthermore, the formation of the ammonia/air flame under the fuel-rich conditions inevitably results in extremely high levels of unburned ammonia and hydrogen production. However, due to the presence of adjacent hydrogen flames, the re-ignition of ammonia and hydrogen may occur, enabling the achievement of high combustion efficiency.

Furthermore, by naturally inducing the breakdown in flame symmetry in the radial (width) direction of the combustion system, it is possible to reduce the combustion vibration.

### BRIEF DESCRIPTION OF THE DRAWINGS

FIG. 1 is a side perspective view of a combustion system according to an embodiment of the present disclosure.

FIG. 2 is a perspective view of a fuel nozzle unit according to an embodiment of the present disclosure.

FIG. 3 is a front end cross-sectional view illustrating a combustion gas flow path of the fuel nozzle unit according to an embodiment of the present disclosure.

FIG. 4 is a rear view illustrating a dump unit of the fuel nozzle unit according to the present disclosure.

FIGS. 5 and 6 are graphs illustrating exhaust emission characteristics of an ammonia/hydrogen/air flame.

FIGS. 7 and 8 are graphs illustrating the internal/external ammonia co-combustion ratio and equivalence ratio according to experimental conditions.

FIG. 9 is a graph showing the results of combustion vibration and major emission concentration measurements according to experimental conditions.

### DETAILED DECRIPTION OF EMBODIMENTS

Hereinafter, an embodiment of the present disclosure will be described in detail with reference to the accompanying drawings.

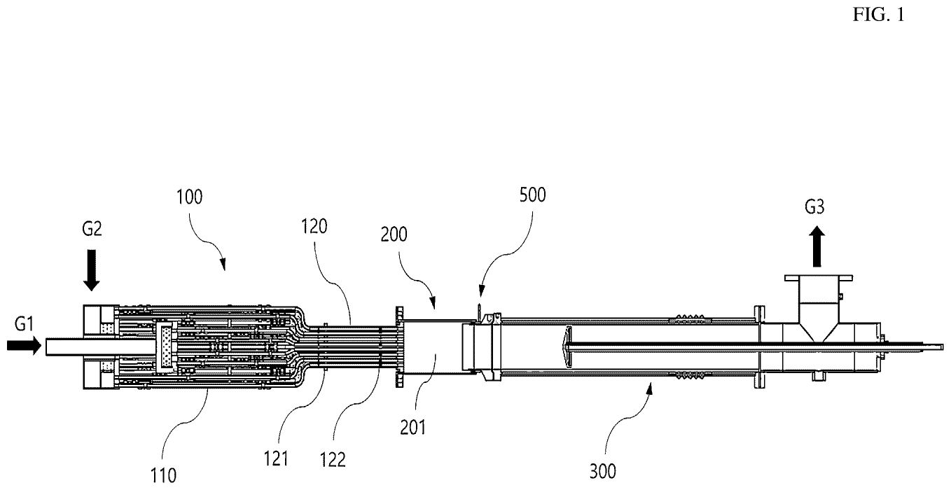

FIG. 1 illustrates a side perspective view of a combustion system 1000 according to an embodiment of the present disclosure.

As illustrated in FIG. 1, the combustion system 1000 may include a fuel nozzle unit 100, a combustion unit 200, a flame tube 300, a sampling unit 500, and a gas analysis unit. The combustion unit 200 has a rear end formed with the fuel nozzle unit 100, and a rear end of the combustion unit 200 is provided with the flame tube 300. The fuel nozzle unit 100 and the combustion unit 200 are formed independently and are configured to be coupled and sealed using room temperature vulcanizing (RTV) silicone. The combustion unit 200 and the flame tube 300 are formed independently and may be bolted together.

The fuel nozzle unit 100 is configured to receive first fuel gas G1 and second fuel gas G2 and supply the first and second fuel gases G1 and G2 to the combustion unit 200. The performance of the combustion system 1000 may be determined by a diameter of the rear end portion 120. Since the front end portion 110 has a manifold-type structure built therein, the diameter of the front end portion 110 may be formed to be larger than that of the rear end portion 120 for ease of processing.

A choked orifice 121 is provided on the front end side of the rear end portion 120. The choked orifice 121 is formed by three holes drilled into a cylindrical stainless steel block with a width of approximately 10 mm, and serves as an upstream acoustic boundary.

Furthermore, a swirler 122 is provided on the rear end side of the rear end portion 120. The swirler 122 is composed of multiple vanes, each 10 mm wide with a swirl angle between 40 to 50°. The swirler 122 may be configured to improve flame stability by applying swirl to the flow of the first and second fuel gases G1 and G2.

The combustion unit 200 is located at the rear end of the fuel nozzle unit 100 and is configured to receive and combust the first and second fuel gases G1 and G2 supplied through the fuel nozzle unit 100. The combustion unit 200 has a combustion region 201 formed therein, and the front end of the combustion region 201 may communicate with the rear end of the fuel nozzle unit 100.

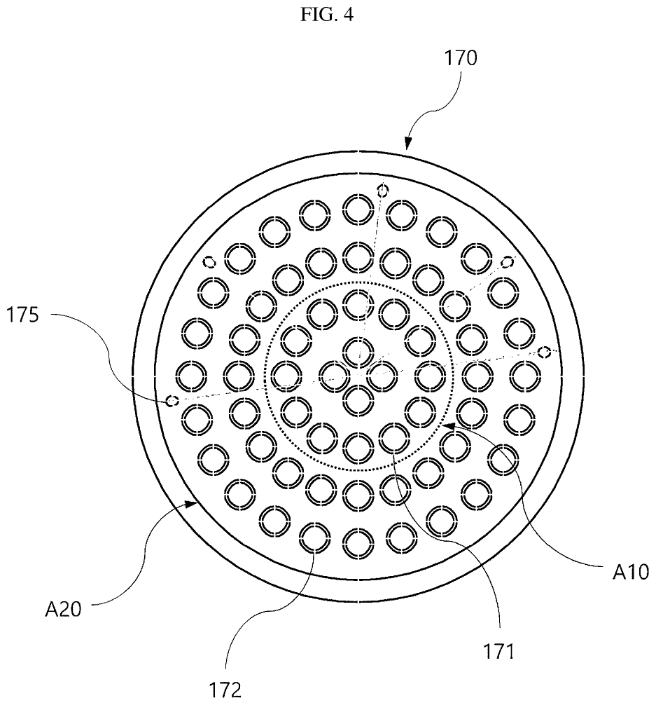

The first and second fuel gases G1 and G2 flowing through the combustion unit 200 are ignited and combusted through an igniter 175 (see FIG. 4) provided at the rear end of the fuel nozzle unit 100, thereby generating an ammonia flame and a hydrogen flame, respectively.

Thermal energy is generated through the ammonia and hydrogen flames generated in the combustion region 201. The combustion gas generated by the flame may be supplied to the flame tube 300 connected to the rear end of the combustion unit 200, so the combustion gas exchanges heat with cooling air or a cooling fluid to be cooled, and is discharged as exhaust gas G3.

In this case, the fuel nozzle unit 100 has the following configuration to independently supply the first fuel gas G1 and the second fuel gas G2 to the combustion chamber 200.

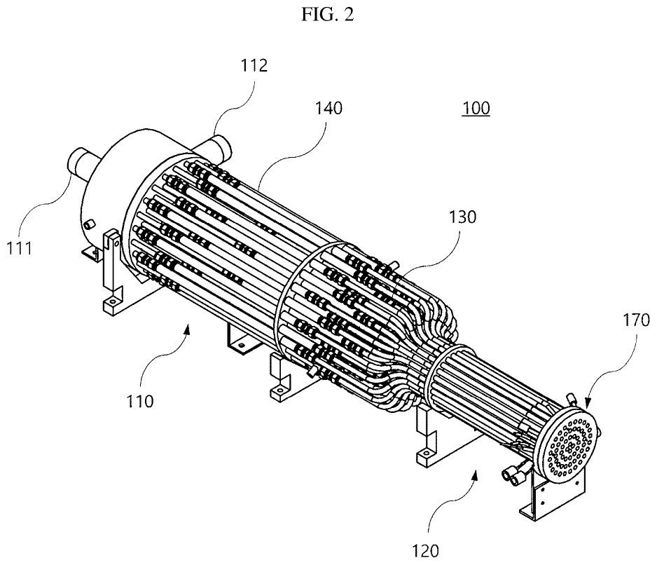

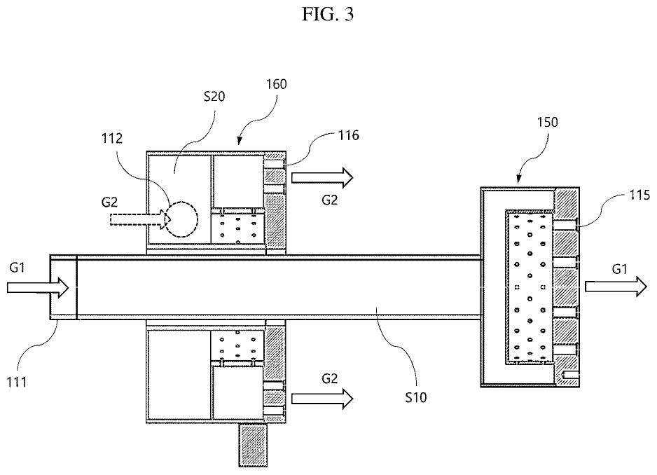

FIG. 2 is a perspective view of the fuel nozzle unit 100 according to an embodiment of the present disclosure, and FIG. 3 is a cross-sectional view of the front end portion 110 illustrating a combustion gas flow path of the fuel nozzle unit 100 according to an embodiment of the present disclosure.

Referring to FIGS. 2 and 3, the fuel nozzle unit includes a plurality of first transfer pipes 130 for transferring the first fuel gas G1 to the combustion chamber 200, and a plurality of second transfer pipes 140 for transferring the second fuel gas G2 to the combustion chamber 200.

More specifically, the fuel nozzle unit 100 is partitioned into the front end portion 110 and the rear end portion 120, and the front end portion 110 may be formed by combining a first housing 150 for transferring the first fuel gas G1 to the plurality of first transfer pipes 130 and a second housing 160 for transferring a second fuel gas G2 to the plurality of second transfer pipes 140. A first space S10 is formed in the first housing 150 so that the first fuel gas G1 flows therein, a first inlet 111 is formed on an upstream side of the first space S10 for receiving the first fuel gas G1, and a plurality of first outlets 115 connected to the first transfer pipes 130 are formed in the rear end. In addition, the second housing 160 has a second space S20 formed therein to allow the second fuel gas G2 to flow, a second inlet 112 is formed on an upstream side of the second space S20 to receive the second fuel gas G2, and a plurality of second outlets 116 connected to the second transfer pipe 140 are formed at the rear end.

In this case, the first housing 150 may be located at a radially inner center so that the first fuel gas G1 flows radially inward and the second fuel gas G2 flows radially outward, and the second housing 160 is formed in a ring shape and coupled so that the first housing 150 penetrates through the center. Accordingly, the plurality of first transfer pipes 130, each connected to the first outlets 115 of the first housing 150, may also be located at a radial center, and the plurality of second transfer pipes 140, each connected to the second outlets 116 of the second housing 160, may be disposed at a radially outer circumference so as to surround the first transfer pipes 130.

Injectors may be provided on the first and second transfer pipes to inject the first or second fuel gas into the combustion chamber.

FIG. 4 illustrates a rear view of a dump unit 170 of the fuel nozzle unit 100 of the present disclosure.

Referring to FIGS. 1 and 4, the dump unit 170 for injecting the first and second fuel gases G1, G2 into the combustion chamber 200 may be formed at the rear end of the fuel nozzle unit 100. As described above, the fuel nozzle unit 100 has the following configuration so as to independently supply the first fuel gas G1 and the second fuel gas G2 to the combustion chamber 200.

The dump unit 170 includes a plurality of first nozzles 171 connected to the rear end of the first transfer pipe 130 and a plurality of second nozzles 172 connected to the rear end of the second transfer pipe 140. Meanwhile, the dump unit 170 includes an inner region A10 communicating with the first inlet 111, and an outer region A20 communicating with the second inlet 112 and formed radially outside an inner region A10 and partitioned from an inner region A10. Accordingly, the first nozzles 171 may be disposed on the inner region A10, and the second nozzles 172 may be disposed on the outer region A20. Accordingly, the first fuel gas G1 is configured to be independently injected into the combustion chamber 200 through the inner region A10, and the second fuel gas G2 is independently injected into the combustion chamber 200 through the outer region A20.

As illustrated, the plurality of first nozzles 171 and the plurality of second nozzles 172 may be spaced apart from each other in the radial and circumferential directions. The first nozzle 171 and the second nozzle 172 each have a diameter of 6.5 mm. 60 nozzles may be arranged in four concentric circles. Sixteen first nozzles 171 may be arranged on a radial center, and 44 second nozzles 172 may be arranged on a radially outer side. That is, the first nozzle 171 may be disposed in the inner region A10, and the second nozzle 172 may be arranged in the outer region A20, forming a multi-stage configuration in the radial direction.

Therefore, the flow rate and equivalence ratio of the first fuel gas G1 and the second fuel gas G2 supplied to the inner region A10 and outer region A20 may be independently controlled.

Meanwhile, while the first and second fuel gases G1 and G2 are injected independently, the injection areas are divided into the inner area A10 and the outer area A20. This allows the flame of the first fuel gas G1 injected through the inner area A10 to move in a manner that surrounds the flame of the second fuel gas G2 injected through the outer area A20.

In particular, the first fuel gas G1 forming the inner flame is composed of a mixture of ammonia and air, and the second fuel gas G2 forming the outer flame is composed of a mixture of hydrogen and air, so that the inner ammonia flame is surrounded by the outer hydrogen flame, thereby maximizing the stability of the ammonia flame.

Meanwhile, the first fuel gas G1 may be a mixture of ammonia/air mixture doped with a small amount of hydrogen. For example, the first fuel gas G1 may be a mixed fuel gas composed of 90% ammonia and 10% hydrogen by volume.

Another reason for independently supplying the first fuel gas G1 and the second fuel gas G2 to the combustion chamber to induce the flame is that the combustion of ammonia and hydrogen in a separate state is more advantageous than co-combustion in terms of nitrogen oxide reduction.

In addition, the first fuel gas G1 may form a rich equivalence ratio condition higher than the stoichiometric equivalence ratio of 1, while the second fuel gas G2 may form a lean equivalence ratio condition lower than the equivalence ratio of 1. This is because the combustion of ammonia in the fuel-rich conditions is advantageous for reducing nitrogen oxide emissions, while the combustion of hydrogen in the fuel-lean conditions is advantageous for reducing nitrogen oxide emissions.

In addition, as illustrated in FIG. 1, the front end portion of the flame tube 300 is provided with a sampling unit 500 that may sample a portion of the exhaust gas G3. The sampling unit 500 may be a typical sampling probe. The combustion gas G3 sampled through the sampling unit 500 is transferred to the analysis unit to analyze and measure the gas components. The analysis unit includes an analyzer and a nitrogen diluter. The analyzer receives the exhaust gas G3 from the sampling unit and analyzes and measures nitrogen oxides, hydrogen, ammonia, and oxygen components. The analyzer may be, for example, Ecom's J2KN Pro equipment.

In addition, the exhaust gas G3 transferred to the analyzer may be diluted with nitrogen through the nitrogen diluter and supplied to the analyzer.

The analyzer is configured to provide feedback on the supply amounts or equivalence ratios of each of the first and second fuel gases G1 and G2 so that nitrogen oxides in the exhaust gas G3 are minimized through the component analysis of the exhaust gas. For example, the nitrogen oxides in the exhaust gas G3 may be measured at a specific time or in real time. When the nitrogen oxides are detected above a certain level, the supply amounts of each fuel gas or the equivalence ratios of each fuel gas may be adjusted to reduce the nitrogen oxides.

A cooling air path and a cooling water path may be formed on the flame tube 300 to cool the exhaust gas through heat exchange with the exhaust gas.

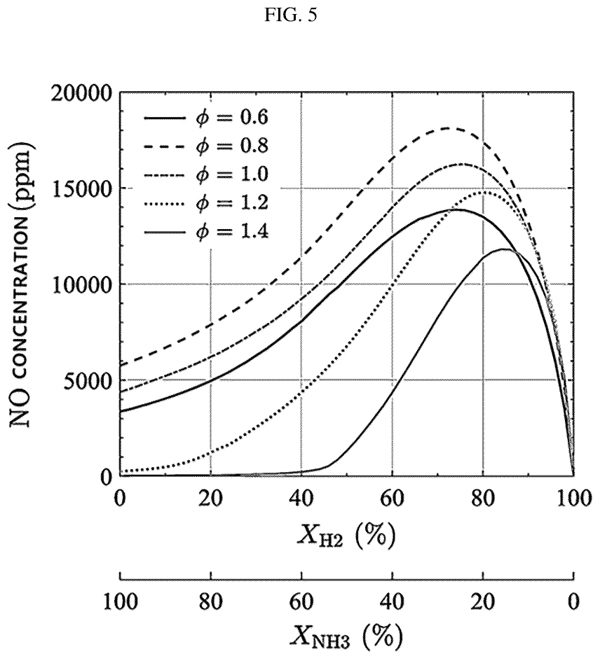

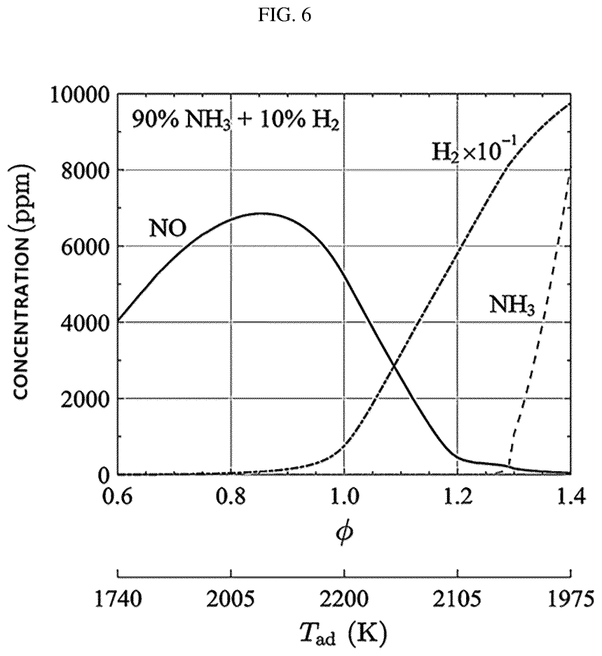

FIG. 5 illustrates a graph showing the nitrogen oxide emission characteristics of the ammonia/hydrogen/air flame according to the hydrogen co-combustion ratio, and FIG. 6 illustrates a graph showing the trend of major exhaust emissions according to the equivalence ratio under the fixed hydrogen co-combustion ratio.

As illustrated in FIG. 5, combustion in 100% hydrogen or 100% ammonia fuels is more effective in reducing nitrogen oxide emissions than co-combustion. Furthermore, as illustrated in FIG. 6, it can be seen that, when co-combustion 90% ammonia and 10% hydrogen, the combustion in the fuel-rich conditions (equivalence ratio 1.4) significantly reduces the nitrogen oxide emissions compared to the fuel-lean conditions (equivalence ratio 0.6). Based on these exhaust emission characteristics of the ammonia/hydrogen/air flames, the present disclosure provides the combustion system described above.

Specifically, to evaluate the applicability of the proposed combustion technique under extreme nitrogen oxide emission conditions, a 30/70 ammonia/hydrogen co-combustion condition was selected as the reference condition. In the first combustion example, only the fuel flows of hydrogen and ammonia supplied to the radially divided inner and outer regions were adjusted to induce the formation of the ammonia flame inside and the hydrogen flame outside. It may be seen that this is consistent with the nitrogen oxide reduction direction of the calculation results presented in FIG. 5. Furthermore, the second combustion embodiment is configured such that, while keeping the flow rates of hydrogen and ammonia supplied to each region fixed, the air supply (flow) between the inner and outer regions is adjusted to form an equivalence ratio in the inner region richer than a specific equivalence ratio, and conversely, to induce an equivalence ratio in the outer region leaner than the specific equivalence ratio. As shown in the results presented in FIG. 6, in the ammonia flame formed in the inner region, the nitrogen oxides decrease significantly as the equivalence ratio increases, thereby significantly reducing the nitrogen oxides.

Meanwhile, as prior research has confirmed that the hydrogen-only flame in the outer region generates nitrogen oxides below 5 ppm in the lean region, the second example is designed to further reduce the nitrogen oxides in the exhaust gas.

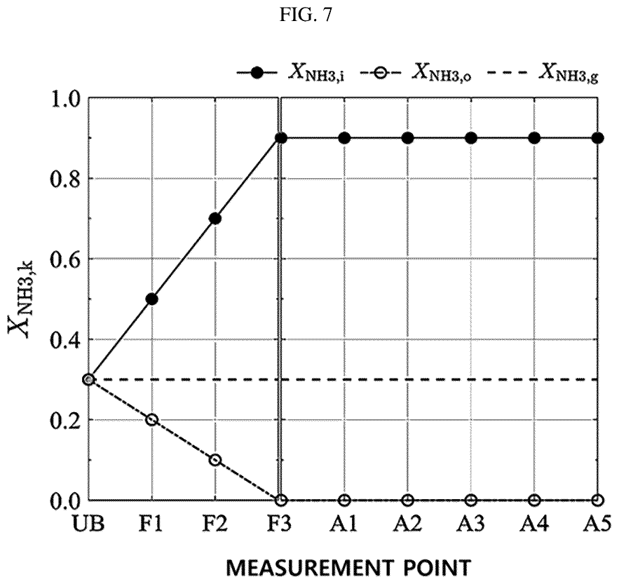

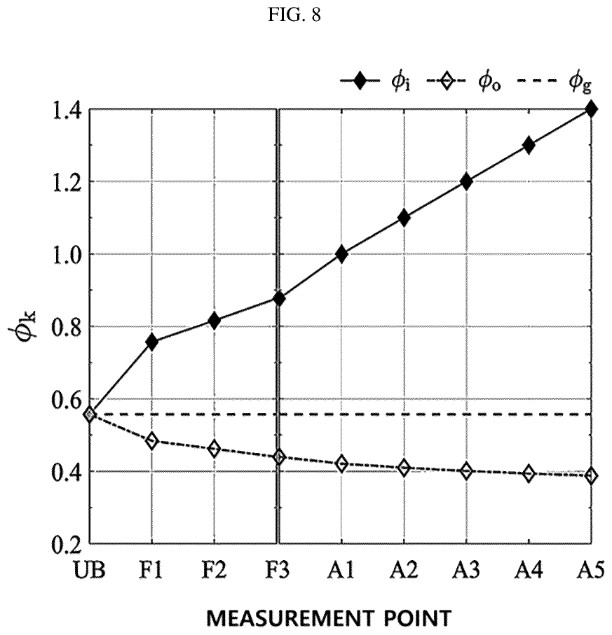

To verify whether the proposed combustion technique operates normally even under the extreme nitrogen oxide emission conditions, the total ammonia co-combustion ratio was fixed at 30%, and the operating conditions of the tested conditions are illustrated in FIGS. 7 and 8. As illustrated in FIGS. 7 and 8, even though ammonia with significantly low reactivity was directly used in a hydrogen-based combustion system, it may be seen that the application of the present disclosure did not cause static instability such as lean blowing, and the flame was even stably maintained in a relatively narrow reaction region.

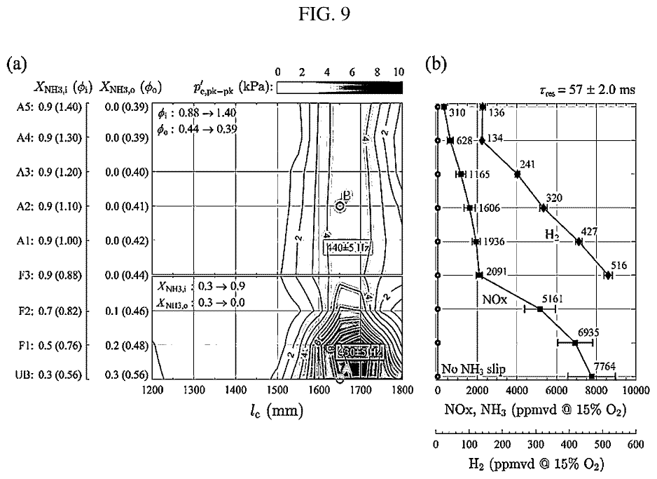

FIG. 9A is a graph showing the results of pressure fluctuation amplitude measurements during the combustion vibration, and FIG. 9B is a graph showing the results of concentration measurements of major exhaust emissions.

Referring to FIG. 9A, the X-axis represents the length of the combustor, the Y-axis represents each test condition, and the color of the contour graph indicates the dynamic pressure amplitude.

To more specifically examine the effectiveness of the staging technique according to the present disclosure, experiments were conducted in two staging sections.

High-amplitude combustion vibration primarily occurs when the length of the combustor is long.

In the first staging, which is fuel staging, the flow rate of air supplied to the inner and outer regions was kept fixed under the UB condition, while only the flow rates of hydrogen and ammonia supplied to the inner and outer regions were switched to perform the test. It can be seen that, based on the reference condition (UB), when the first staging technique was applied (UB->F3), the amplitude of pressure fluctuations was reduced by half. Therefore, the combustion vibration may be reduced and the control effect of major exhaust emissions was demonstrated.

In the second staging, which is air staging, under the F3 condition, the flow rates of hydrogen and ammonia supplied to the inner and outer regions were kept fixed, while a portion of the air supplied to the inner region was redirected to the outer region for the test. This second staging technique had minimal impact on combustion vibration intensity, but demonstrated effective control of major exhaust emissions.

Referring to FIG. 9B, the X-axis represents concentration, and the Y-axis represents each test condition (shared with the Y-axis in FIG. 9A).

When all of the proposed staging techniques were applied, nitrogen oxides were reduced by 96% (from 7764 to 310 ppm) compared to the reference condition (UB), no un-combusted ammonia was generated, and It can be seen that the hydrogen concentration at the rear end of the combustor sharply decreases to around 130 ppm. (130 ppm is lower than the hydrogen slip generated during hydrogen combustion)

The present disclosure is not to be construed as being limited to the above-mentioned embodiment. The present disclosure may be applied to various fields and may be variously modified by those skilled in the art without departing from the scope of the present disclosure claimed in the claims. Therefore, it is obvious to those skilled in the art that these alterations and modifications fall within the scope of the present disclosure.

What is claimed is:

1. A combustion system, comprising:
a combustion unit where first and second fuel gases are supplied and combusted; and
a fuel nozzle unit connected to a front end of the combustion unit and supplying the first fuel gas to the combustion unit through a plurality of first nozzles and supplying the second fuel gas to the combustion unit through a plurality of second nozzles,
wherein the fuel nozzle unit includes the first and second nozzles partitioned from each other to independently control flow rates of each of the first and second fuel gases.

2. The combustion system of claim 1, wherein the first fuel gas is one of a mixture of ammonia and air or a mixture of hydrogen and air, and
the second fuel gas is the other of the mixture of ammonia and air or the mixture of hydrogen and air.

3. The combustion system of claim 2, wherein a rear end of the fuel nozzle unit is provided with a dump unit having the first and second nozzles,
the dump unit is partitioned into an inner region formed at a radial center and an outer region formed around a radially outer circumference of the inner region, and
the first nozzle is disposed in the inner region, and the second nozzle is disposed in the outer region.

4. The combustion system of claim 3, wherein the first nozzle is supplied with a first fuel gas which is the mixture of ammonia and air, and
the second nozzle is supplied with a second fuel gas which is the mixture of hydrogen and air.

5. The combustion system of claim 4, wherein the first fuel gas is supplied to the first nozzle in a rich condition with an equivalence ratio of 1 or greater, and
the second fuel gas is supplied to the second nozzle in a lean condition with an equivalence ratio of less than 1.

6. The combustion system of claim 1, further comprising:
a sampling unit sampling exhaust gas emitted from the combustion unit; and
an analysis unit analyzing components of the exhaust gas sampled through the sampling unit.

7. The combustion system of claim 6, further comprising:
a control unit that controls the flow rate and equivalence ratio of the first and second fuel gases when the nitrogen oxides analyzed by the analysis unit are greater than or equal to a predetermined level.

8. The combustion system of claim 7, wherein the control unit detects the components of the exhaust gas in real time or at specific intervals and provides feedback on a hydrogen mole fraction or the supply amount of additional fuel gas.

9. The combustion system of claim 1, wherein the fuel nozzle unit includes:
a first housing receiving the first fuel gas and transferring the received first fuel gas to a plurality of first nozzles;
a second housing receiving the second fuel gas and transferring the received second fuel gas to a plurality of second nozzles;
a plurality of first transfer pipes connecting a plurality of first outlets formed in the first housing to the plurality of first nozzles, respectively; and
a plurality of second transfer pipes connecting a plurality of second outlets formed in the second housing to the plurality of second nozzles, respectively.

10. The combustion system of claim 9, wherein the first housing is cylindrical, and has a front end formed with a first inlet for receiving the first fuel gas and a rear end formed with a plurality of first outlets formed for emitting the first fuel gas, and
the second housing is ring-shaped, and is connected to the first housing so that the first housing passes through the center thereof, and has a side surface formed with a second inlet for receiving the second fuel gas and a rear end formed with a plurality of second outlets for discharging the second fuel gas.

11. The combustion system of claim 10, wherein a plurality of first transfer pipes are spaced apart from each other at a radial center of the first fuel nozzle unit, and
a plurality of second transfer pipes are spaced apart from each other at a radial outer periphery so as to surround the first transfer pipes.

12. The combustion system of claim 4, wherein a hydrogen flame generated by the second fuel gas injected from the second nozzle is configured to surround an ammonia flame generated by the first fuel gas injected from the first nozzle.
